(19) United States
(12) Patent Application Publication
(10) Pub. No.: US 2025/0370296 A1
(43) Pub. Date: Dec. 4, 2025

(54) OPTICAL MEMBER, LIGHT SOURCE MODULE, AND LIQUID CRYSTAL DISPLAY DEVICE

(71) Applicant: Nichia Corporation, Anan-shi (JP)

(72) Inventor: Norimasa YOSHIDA, Komatsushima-shi (JP)

(73) Assignee: Nichia Corporation, Anan-shi (JP)

(21) Appl. No.: 19/219,546

(22) Filed: May 27, 2025

(30) Foreign Application Priority Data
May 30, 2024 (JP) 2024-087700

(51) Int. Cl. G02F 1/1335

(52) U.S. Cl. CPC G02F 1/133607

(57) ABSTRACT

An optical member includes: a plurality of light control units, each including: an upper surface serving as an emitting surface, a first incident surface located below the emitting surface, a second incident surface located at an outer periphery of the first incident surface in a top view, and extending downward from a first incident surface side, and a reflective surface located at an outer periphery of the second incident surface in the top view, and inclined in a direction away from a center of the light control unit so as to extend closer to the emitting surface from a vicinity of the second incident surface. The light control units are configured such that light incident on the first incident surface and the second incident surface, and light reflected by the reflective surface are emitted from the emitting surface.

### CROSS-REFERENCE TO RELATED APPLICATION

This application claims priority to Japanese Patent Application No. 2024-087700, filed on May 30, 2024, the disclosure of which is hereby incorporated by reference in its entirety.

### TECHNICAL FIELD

The present disclosure relates to an optical member, a light source module, and a liquid crystal display device.

### BACKGROUND

A virtual image display device is disclosed, including an illumination unit that emits illumination light, an image forming unit that forms an image by transmission of the illumination light and emits display light of the image, and a focusing unit that focuses the illumination light toward the image forming unit (See, for example, Japanese Patent Publication No. 2022-94052). The focusing unit focuses the illumination light from the illumination unit toward the image forming unit. The focusing unit primarily includes a lens array. The lens array is a TIR lens array.

### SUMMARY

An object of the present disclosure is to provide an optical member that can reduce brightness unevenness when disposed above a light source. Another object of the present disclosure is to provide a light source module including this optical member. Another object of the present disclosure is to provide a liquid crystal display device including this light source module.

An optical member according to an embodiment of the present disclosure includes a plurality of light control units, in which each of the light control units includes an upper surface serving as an emitting surface, a first incident surface located below the emitting surface, a second incident surface located at an outer periphery of the first incident surface in a top view, and extending downward from the first incident surface, and a reflective surface located at an outer periphery of the second incident surface in a top view, and inclined in a direction away from a center of the light control unit so as to extend closer to the emitting surface from a vicinity of the second incident surface, light incident on the first incident surface and the second incident surface, and light reflected by the reflective surface are emitted from the emitting surface, the first incident surface is a convex surface curved in a direction away from the emitting surface, the emitting surface is a convex surface curved in a direction away from the first incident surface, a radius of curvature of the first incident surface is larger than a radius of curvature of the emitting surface in a cross-sectional view, and the emitting surfaces of the light control units adjacent to each other are directly connected to each other.

An optical member according to an embodiment of the present disclosure includes a plurality of light control units, in which each of the light control units includes an upper surface serving as an emitting surface, a first incident surface located below the emitting surface, a second incident surface located at an outer periphery of the first incident surface in a top view, and extending downward from the first incident surface, and a reflective surface located at an outer periphery of the second incident surface in a top view, and inclined in a direction away from a center of the light control unit so as to extend closer to the emitting surface from a vicinity of the second incident surface, light incident on the first incident surface and the second incident surface, and light reflected by the reflective surface are emitted from the emitting surface, the first incident surface is a flat surface, the emitting surface is a convex surface curved in a direction away from the first incident surface, and the emitting surfaces of the light control units adjacent to each other are directly connected to each other.

A light source module according to an embodiment of the present disclosure includes a planar light source including a substrate and a plurality of light sources disposed on the substrate, and the optical member according to the embodiment of the present disclosure disposed above the plurality of light sources.

A liquid crystal display device according to an embodiment of the present disclosure includes the light source module according to the embodiment of the present disclosure.

According to an embodiment of the present disclosure, an optical member that can reduce brightness unevenness when disposed above a light source can be provided. In addition, a light source module including this optical member can be provided. In addition, a liquid crystal display device including this light source module can be provided.

### BRIEF DESCRIPTION OF DRAWINGS

FIG. 1 is a schematic perspective view exemplifying an optical member according to a first embodiment.

FIG. 2 is a schematic top view exemplifying the optical member according to the first embodiment.

FIG. 3 is a schematic bottom view exemplifying the optical member according to the first embodiment.

FIG. 4 is a schematic cross-sectional view exemplifying the optical member according to the first embodiment taken along the line IV-IV of FIG. 2.

FIG. 5 is a result of optical path simulation of light incident on a light control unit.

FIG. 6 is a schematic top view illustrating inclination of a reflective surface of the optical member according to the first embodiment.

FIG. 7 illustrates schematic views (part 1) each illustrating a cross-sectional shape of a light control unit when an emitting surface has a shape of a rectangle.

FIG. 8 is a schematic perspective view of the light control unit illustrated in FIG. 7.

FIG. 9 illustrates schematic views (part 2) each illustrating the cross-sectional shape of the light control unit when the emitting surface has a shape of a rectangle.

FIG. 10 is a schematic perspective view of the light control unit illustrated in FIG. 9.

FIG. 11 is a schematic cross-sectional view exemplifying an optical member according to a first modified example of the first embodiment.

FIG. 12 is a schematic top view exemplifying a planar light source.

FIG. 13 is a schematic top view exemplifying a light source module including a planar light source and an optical member.

FIG. 14 is a schematic cross-sectional view exemplifying the light source module including the planar light source and the optical member taken along the line XIV-XIV in FIG. 13.

FIG. 15 is a schematic cross-sectional view exemplifying a light source mounted on the planar light source.

FIG. 16 is a schematic partial cross-sectional view (part 1) exemplifying another example of the light source module.

FIG. 17 is a schematic partial cross-sectional view (part 2) exemplifying another example of the light source module.

FIG. 18 is a schematic partial cross-sectional view exemplifying a liquid crystal display device including a light source module.

### DETAILED DESCRIPTIONS

Hereinafter, embodiments for carrying out the invention are described with reference to the drawings. In the following description, terms indicating specific directions or positions (e.g., “upper,” “lower,” “horizontal,” “vertical,” and other terms related to those terms) are used as necessary. The use of those terms, however, is to facilitate understanding of the invention with reference to the drawings, and the technical scope of the present invention is not limited by the meaning of those terms. In addition, parts having the same reference numerals appearing in multiple drawings indicate identical or equivalent parts or members.

In the present disclosure, polygons such as triangles and quadrangles, including shapes in which the corners of the polygon are rounded, chamfered, beveled, coved, and the like, are referred to as polygons. A shape obtained by processing not only the corners (ends of a side) but also an intermediate portion of the side is similarly referred to as a polygon. That is, a shape that is partially processed while leaving the polygon as the base is included in the interpretation of the “polygon” described in the present disclosure.

The same applies not only to polygons but also to words representing specific shapes such as trapezoids, circles, protrusions, and recessions. The same applies when dealing with each side forming that shape. That is, even when processing is performed on a corner or an intermediate portion of a certain side, the interpretation of “side” includes the processed portion. When a “polygon” or a “side” not partially processed is to be distinguished from a processed shape, “strict” will be added to the description as in, for example, “strict quadrangle”.

Further, the following embodiments exemplify an optical member and the like for embodying a technical concept of the present invention, but the present invention is not limited to the description below. In addition, unless otherwise specified, the dimensions, materials, shapes, relative arrangements, and the like of constituent elements described below are not intended to limit the scope of the present invention to those alone and are merely exemplary. Additionally, the contents described in one embodiment can be applied to other embodiments and modification examples. Further, the size, positional relationship, and the like of the members illustrated in the drawings can be exaggerated to clarify the explanation. Furthermore, to avoid excessive complication of the drawings, a schematic view in which some elements are not illustrated may be used, or an end view illustrating only a cutting surface may be used as a cross-sectional view.

### First Embodiment

### Optical Member 1

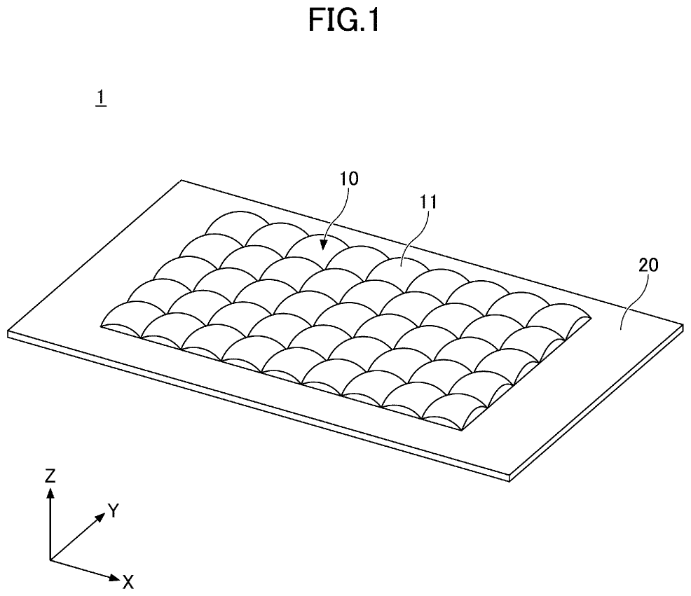

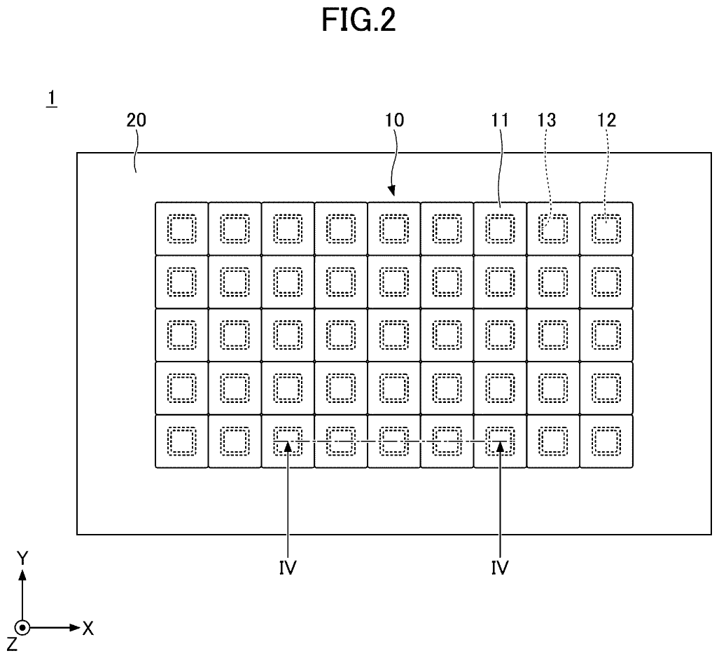

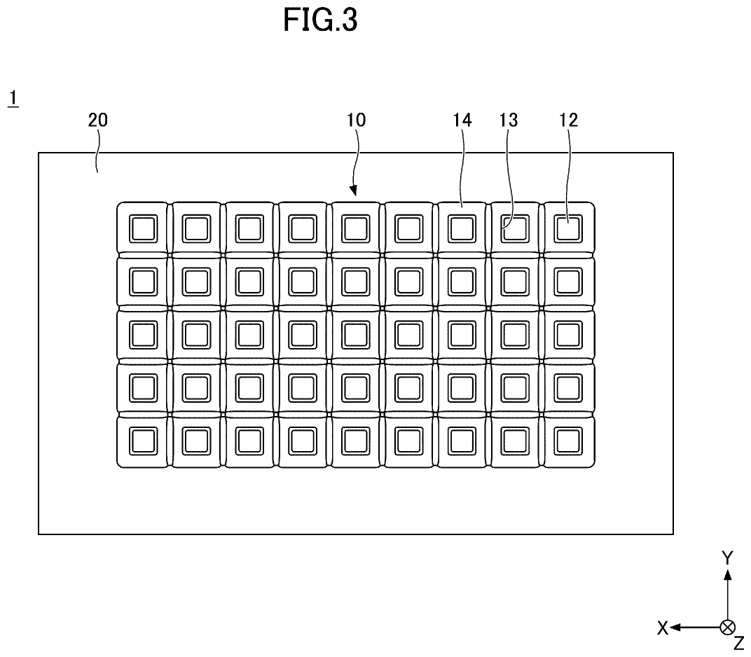

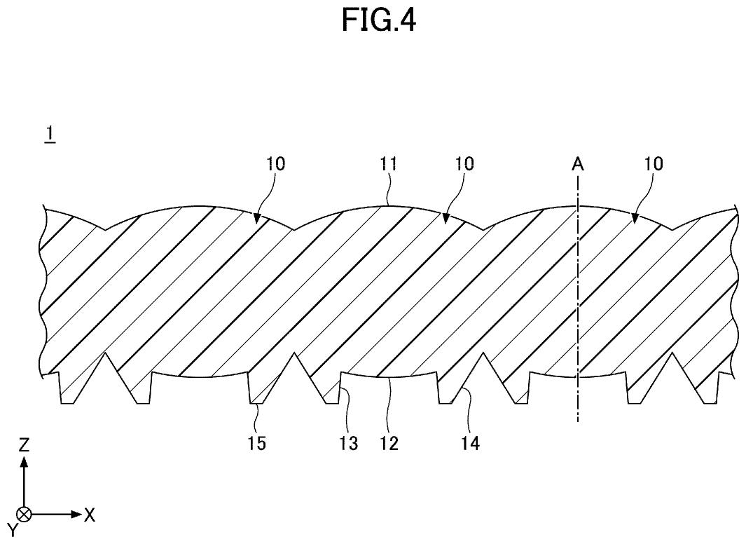

FIG. 1 is a schematic perspective view exemplifying an optical member according to a first embodiment. FIG. 2 is a schematic top view exemplifying the optical member according to the first embodiment. FIG. 3 is a schematic bottom view exemplifying the optical member according to the first embodiment. FIG. 4 is a schematic cross-sectional view exemplifying the optical member according to the first embodiment taken along the line IV-IV of FIG. 2. In FIGS. 1 to 4, an X-axis, a Y-axis, and a Z-axis that are mutually orthogonal are illustrated for reference.

As illustrated in FIGS. 1 to 4, an optical member 1 includes a plurality of light control units 10. In the example of FIGS. 1 to 4, the light control units 10 are two-dimensionally arranged in a matrix of five rows and nine columns. The X-axis direction is a row direction, and the Y-axis direction is a column direction. In other words, the center of the light control unit 10 is located at the center of square lattice points. The light control units 10 are arranged, for example, at a constant pitch in the X-axis direction and the Y-axis direction. The arrangement of the light control units 10 is not limited to the example illustrated in FIGS. 1 to 4. For example, the center of light control unit 10 may be located at the center of hexagonal lattice points.

Each of the light control units 10 includes a total internal reflection (TIR) lens. Each of the light control units 10 has, for example, a shape of a quadrangle in a top view. Each of the light control units 10 may have a shape of a square or a rectangle in a top view. The “top view” refers to viewing an object from a Z axis + direction to a Z axis − direction.

Each of the light control units 10 includes an upper surface 11 serving as an emitting surface, a first incident surface 12 located below the emitting surface 11, a second incident surface 13 located at an outer periphery of the first incident surface 12 in a top view and extending downward from the first incident surface 12, and a reflective surface 14 located at an outer periphery of the second incident surface 13 in a top view, and inclined in a direction away from the center of the light control unit 10 so as to extend closer to the emitting surface 11 from a vicinity of the second incident surface 13. Light incident on the first incident surface 12 and the second incident surface 13, and light reflected by the reflective surface 14 are emitted from the emitting surface 11.

The emitting surface 11 is a convex surface curved in a direction away from the first incident surface 12. In other words, the emitting surface 11 has an arc shape in a cross-sectional view. The emitting surface 11 has, for example, a shape of a quadrangle in a top view. The emitting surface 11 may have a shape of a square or a rectangle in a top view. In the example of FIGS. 1 to 4, the emitting surface 11 has a shape of a square in a top view. A length of one side of the emitting surface 11 is, for example, in a range from 1 mm to 20 mm in a top view. The emitting surfaces 11 of the light control units 10 adjacent to each other are directly connected to each other. That is, there is no flat surface or the like between the emitting surfaces 11 of the adjacent light control units 10.

The first incident surface 12 is a convex surface curved in a direction away from the emitting surface 11. The first incident surface 12 has, for example, a shape of a quadrangle in a top view. The first incident surface 12 may have a shape of a square or a rectangle in a top view. The first incident surface 12 may have a shape of a circle in a top view. The circle described herein includes a perfect circle, an ellipse, and a shape forming a horizontally and vertically symmetrical ring.

In the example of FIGS. 1 to 4, the first incident surface 12 has a shape of a square in a top view. The first incident surface 12 is smaller than the emitting surface 11 in a top view. The first incident surface 12 overlaps the emitting surface 11 in a top view. A radius of curvature of the first incident surface 12 is larger than a radius of curvature of the emitting surface 11 in a cross-sectional view. The cross-section described herein is a vertical cross-section cut along the Z direction.

The second incident surface 13 is inclined in a direction closer to the center of the light control unit 10 as the second incident surface 13 extends closer to the first incident surface 12. The second incident surface 13 extends, for example, in a plane inclined with respect to a horizontal plane when the optical member 1 is placed on the horizontal plane with the first incident surface 12 facing downward. In this case, an angle formed by the horizontal plane and the second incident surface 13 may be, for example, in a range from 80 degrees to less than 90 degrees. The second incident surface 13 has a rectangular frame shape in a top view. The horizontal plane is a plane parallel to a plane including the X-axis and the Y-axis.

The reflective surface 14 extends, for example, in a plane inclined with respect to the horizontal plane when the optical member 1 is placed on the horizontal plane with the first incident surface 12 facing downward. In this case, an angle formed by the horizontal plane and the reflective surface 14 may be, for example, in a range from 40 degrees to 70 degrees. The reflective surface 14 has a rectangular frame shape in a top view.

In the examples of FIGS. 1 to 4, each of the light control units 10 further includes a connection surface 15 connecting the reflective surface 14 and the second incident surface 13. The connection surface 15 has a rectangular frame shape in a top view. The connection surface 15 extends, for example, in a plane parallel to the horizontal plane when the optical member 1 is placed on the horizontal plane with the first incident surface 12 facing downward. Each of the light control units 10 need not include the connection surface 15, and the reflective surface 14 and the second incident surface 13 may be directly connected to each other.

In FIG. 4, a straight line A connects the center of the first incident surface 12 and the center of the emitting surface 11 in a top view, and is an optical axis of the light control unit 10. The straight line A is parallel to the Z-axis. In other words, in the example of FIG. 4, the center of the first incident surface 12 coincides with the center of the emitting surface 11 in a top view. The expression “the centers coincide with each other in a top view” refers to a case in which a distance between the centers of comparison targets is 0.1 mm or less in a top view.

In the example of FIGS. 1 to 4, the optical member 1 further includes a frame portion 20 surrounding the outside of the plurality of light control units 10 in a top view. The frame portion 20 is provided between the first incident surface 12 and the emitting surface 11 of the light control unit 10 in the Z-axis direction. An upper surface of the frame portion 20 extends, for example, in the same plane as a position at which the emitting surfaces 11 of the adjacent light control units 10 are connected to each other. The optical member 1 need not include the frame portion 20.

As a material of the light control unit 10, a polycarbonate resin, an acrylic resin, a cycloolefin polymer (COP), a silicone resin, or the like can be used. The pitch of the light control units 10 can be, for example, in a range from 1 mm to 20 mm. The “pitch” described herein refers to a distance between the centers of two adjacent light control units 10. The light control units 10 can be manufactured by, for example, molding. In the case in which the optical member 1 includes the frame portion 20, for example, the frame portion 20 can be monolithically formed with the light control units 10 using the same material.

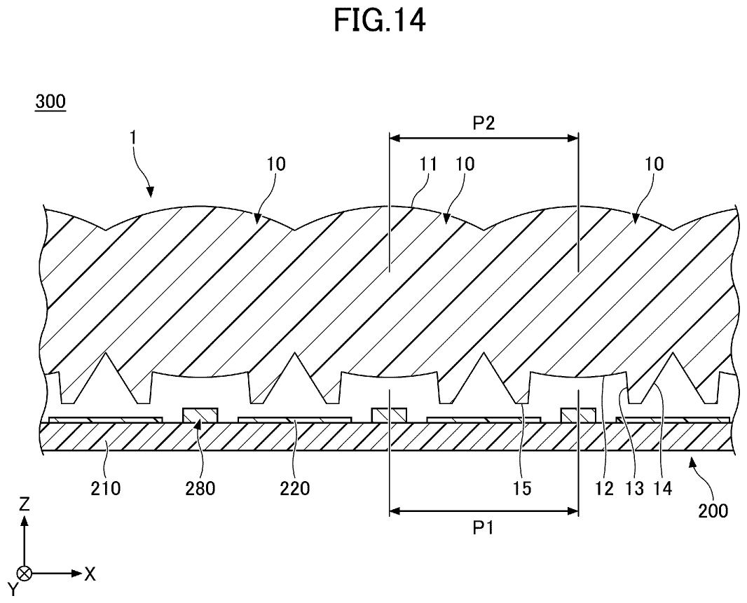

As described above, in the optical member 1, each of the light control units 10 includes the TIR lens. Thus, when the optical member 1 is used in combination with light sources, and the light control units 10 are disposed above the light sources (for example, see FIG. 14 described later), the brightness of light emitted from the optical member 1 can be improved.

Further, in each of the light control units 10 of the optical member 1, the first incident surface 12 is the convex surface curved in the direction away from the emitting surface 11, and the emitting surface 11 is the convex surface curved in the direction away from the first incident surface 12. The radius of curvature of the first incident surface 12 is larger than the radius of curvature of the emitting surface 11, and the emitting surfaces 11 of the adjacent light control units 10 are directly connected to each other. Thus, when the optical member 1 is used in combination with the light source and the light control units 10 are disposed above the light source, uniformity of the light emitted from the optical member 1 is improved. Improving the uniformity of light is substantially synonymous with reducing brightness unevenness. The reduction of the brightness unevenness will be described in detail below.

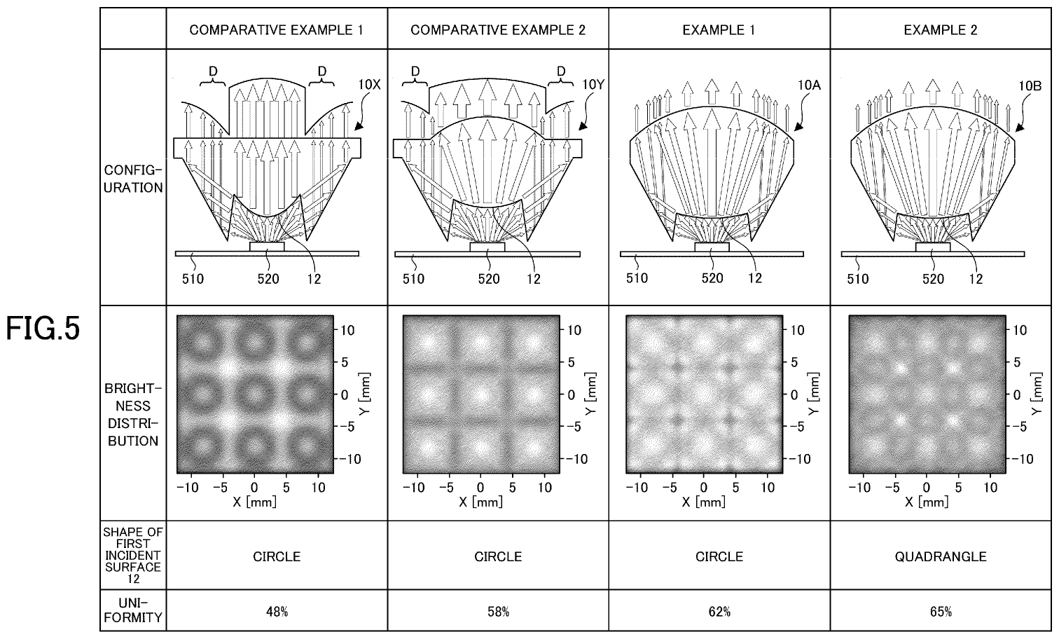

FIG. 5 is a result of optical path simulation of light incident on the light control unit. FIG. 5 illustrates a case in which a light control unit 10X is used as Comparative Example 1, a case in which a light control unit 10Y is used as Comparative Example 2, a case in which a light control unit 10A is used as Example 1, and a case in which a light control unit 10B is used as Example 2.

The light control unit 10X, the light control unit 10Y, and the light control units 10A and 10B are different in the shape of the emitting surface. The emitting surface of the light control unit 10X includes only a flat surface. The emitting surface of the light control unit 10Y includes a convex surface and a flat surface located around the convex surface in a top view. Similarly to the light control unit 10 described above, the emitting surface of each of the light control units 10A and 10B includes only a convex surface. The first incident surface 12 of each of the light control unit 10X, the light control unit 10Y, and the light control unit 10A has a shape of a circle in a top view. On the other hand, similarly to the light control unit 10 described above, the first incident surface 12 of the light control unit 10B has a shape of a quadrangle in a top view.

In FIG. 5, light of Lambertian light distribution is incident on each of the light control units from a light source 520 disposed on a substrate 510, passes through an optical path indicated by arrows, and is emitted from the emitting surface. Thicknesses of the arrows in FIG. 5 schematically indicate an intensity of each light. FIG. 5 illustrates a brightness distribution on the emitting surface, a shape of the first incident surface 12, and uniformity in addition to a configuration of each of the light control units. The uniformity is a ratio of the lowest brightness to the highest brightness in the brightness distribution, and as the numerical value of this ratio is higher, the uniformity is improved.

The light control unit 10X according to Comparative Example 1 can totally reflect light traveling from the light source 520 in an obliquely upward direction nearly in the lateral direction by the reflective surface and extract the light from the emitting surface. However, the brightness of the light totally reflected by the reflective surface is lower than the brightness of the light emitted from the emitting surface without reaching the reflective surface, and thus the brightness in a region D is extremely lowered and the region D becomes dark. As a result, the brightness unevenness of the light emitted from the emitting surface was very large, and the uniformity was 48%. In addition, the brightness difference between the region D and a region inside the region D is large, resulting in a discontinuous brightness distribution at the boundary between the region D and the region inside the region D.

In the light control unit 10Y according to Comparative Example 2, the first incident surface 12 has a smaller curvature than that of the light control unit 10X, and a part of the emitting surface is a convex surface. With this configuration, the spread of the light incident from the first incident surface 12 inside the light control unit 10Y is increased, and thus the brightness distribution is improved as compared with the Comparative Example 1, but the brightness in the region D is not sufficiently improved. As a result, the brightness unevenness of the light emitted from the emitting surface was slightly large, and the uniformity was 58%. In addition, although Comparative Example 2 is improved as compared with Comparative Example 1, the brightness difference between the region D and the region inside the region D is still large, resulting in a discontinuous brightness distribution at the boundary between the region D and the region inside the region D. In Comparative Example 2, a method may be considered in which a light diffusion effect is imparted to the convex surface of the emitting surface to reduce the brightness on the convex surface and improve the uniformity. However, a sufficient effect cannot be obtained, and the emission efficiency decreases. Thus, this method cannot be considered preferable.

In the light control unit 10A according to Example 1, the brightness distribution was improved as compared with Comparative Examples 1 and 2 and the uniformity was 62%. The reason is as follows.

First, in the light control unit 10A, the radius of curvature of the first incident surface 12 is increased, so that a degree of light focusing on the incident side can be reduced, and the light can be spread inside the light control unit 10A. Thus, the amount of light focused on the vicinity of the center of the emitting surface can be reduced, and the light can be dispersed over the entire emitting surface. Thereafter, the radius of curvature on the emitting side is adjusted, so that the dispersed light is focused on the emitting surface side. As a result, it is possible to suppress the emitting surface only near the center from becoming bright and thus improve the uniformity.

Subsequently, in the light control unit 10A, the entire emitting surface is formed into a convex surface, so that light can be easily focused, and uniformity can be improved. Furthermore, the emitting surface of the light control unit 10A does not include the flat surface unlike Comparative Example 1 and Comparative Example 2, and thus a discontinuous brightness distribution is less likely to occur, so that the brightness unevenness can be reduced.

In the light control unit 10B according to Example 2, the brightness distribution was further improved as compared with the light control unit 10A according to Example 1, and the uniformity was 65%. This is because when the shape of the first incident surface 12 is a quadrangle in a top view, light easily reaches the vicinity of a portion at which corner portions of the light control units 10B adjacent to each other are in contact with each other in a top view, as compared with a case in which the shape of the first incident surface 12 is a circle in a top view. As described above, when the shape of the first incident surface 12 is a quadrangle in a top view, the brightness unevenness can be further reduced as compared with the case in which the shape of the first incident surface 12 is a circle in a top view. Texturing is performed on the emitting surface, i.e., fine protrusions and recessions are formed on the emitting surface, so that light is diffused when passing through the emitting surface, and thus the uniformity of the brightness can be further improved as compared with Example 2.

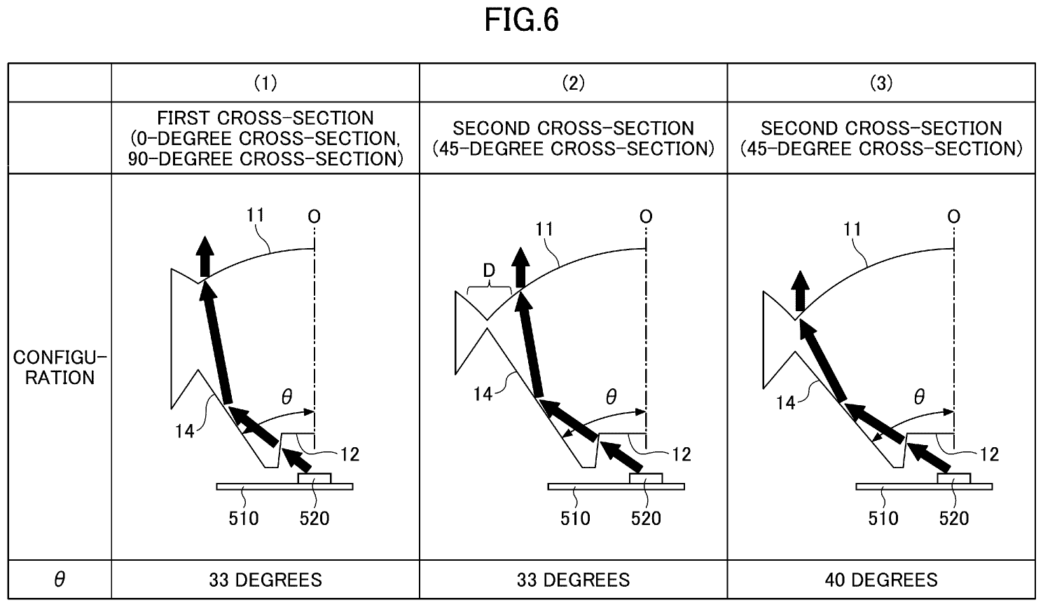

FIG. 6 is a schematic view illustrating inclination of a reflective surface in the optical member according to the first embodiment. In FIG. 6, (1) illustrates a half of a first cross-section of the light control unit, and (2) and (3) each illustrates a half of a second cross-section of the light control unit. The first cross-section is a vertical cross-section cut parallel to one side of the emitting surface 11 and passing through the center of the emitting surface 11. For example, it is assumed that the emitting surface 11 has a shape of a quadrangle in a top view, a direction in which one of two sides of the quadrangle orthogonal to each other extends is an X-axis direction, a direction in which the other extends is a Y-axis direction, and a direction perpendicular to the X-axis direction and the Y-axis direction is a Z-axis direction. In this case, the first cross-section is a cross-section (0-degree cross-section) cut along a plane passing through the center of the emitting surface 11 and parallel to the XZ plane, or a cross-section (90-degree cross-section) cut along a plane parallel to the YZ plane. For example, when the emitting surface 11 has a shape of a square in a top view, the 0-degree cross-section and the 90-degree cross-section coincide with each other. The second cross-section is a vertical cross-section cut along a diagonal line of the emitting surface 11. When the emitting surface 11 has a shape of a square in a top view, the second cross-section is a 45-degree cross-section inclined by 45 degrees with respect to the 0-degree cross-section and the 90-degree cross-section in a top view.

In (1) to (3) of FIG. 6, the shape of the first incident surface 12 is a square. In (1) to (3) of FIG. 6, a straight line O is a center line of the light control unit. In other words, the straight line O is parallel to the Z-axis direction and passes through the center of the emitting surface 11. In the first cross-section illustrated in (1), an angle θ formed by the center line of the light control unit and the reflective surface 14 is 33 degrees. In other words, the angle of the reflective surface 14 relative to the horizontal plane is 57 degrees. At this time, the light reflected by the reflective surface 14 reaches the vicinity of the outermost periphery of the emitting surface 11 in the 0-degree direction and the 90-degree direction, and in these directions, the vicinity of the outermost periphery of the emitting surface 11 does not become dark.

On the other hand, as in the second cross-section illustrated in (2), when the angle θ is set to the same value as that of the first cross-section illustrated in (1), the light reflected by the reflective surface 14 does not reach the vicinity of the outermost periphery of the emitting surface 11 in the 45-degree direction. Thus, the vicinity of the region D located at the outermost periphery of the emitting surface 11 becomes darker in the 45-degree direction than in the 0-degree direction and the 90-degree direction. As a result, the brightness unevenness occurs.

Thus, the value of the angle θ is preferably changed between the first cross-section and the second cross-section. Specifically, as in the second cross-section illustrated in (3), the angle θ is preferably set larger than that of the first cross-section illustrated in (1). In the second cross-section illustrated in (3), the angle θ is 40 degrees. In other words, the angle of the reflective surface 14 relative to the horizontal plane is 50 degrees. Thus, the light reflected by the reflective surface 14 reaches the vicinity of the outermost periphery of the emitting surface 11 even in the 45-degree direction, so that the vicinity of the outermost periphery of the emitting surface 11 does not become dark even in this direction. As a result, the uniformity of the brightness in the vicinity of the outermost periphery of the emitting surface 11 is improved in the 0-degree direction, the 90-degree direction, and the 45-degree direction, so that the brightness unevenness of the light emitted from the emitting surface 11 can be reduced.

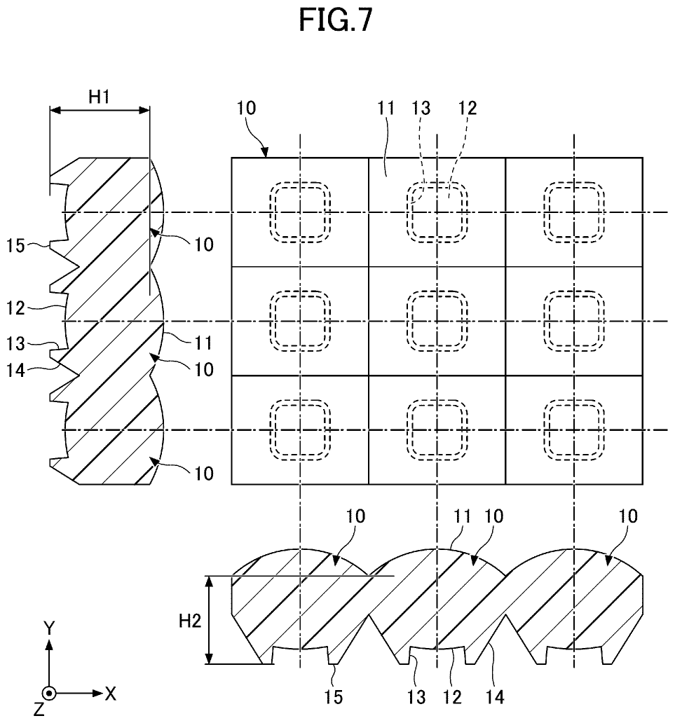

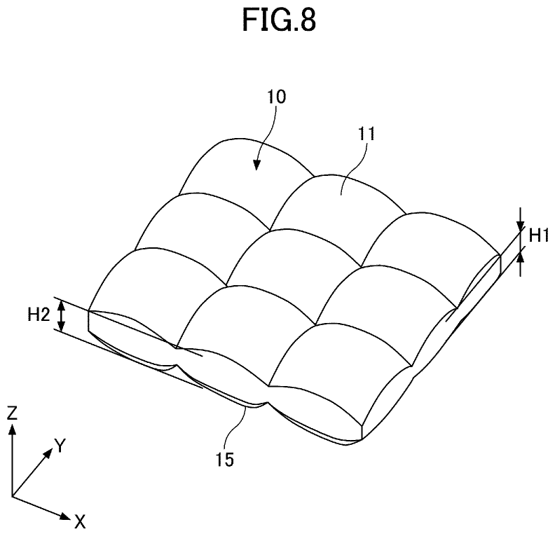

FIG. 7 illustrates schematic views (part 1) each illustrating a cross-sectional shape of a light control unit when an emitting surface is a rectangle. In FIG. 7, the schematic view on the upper right is a top view. The schematic view on the upper left is a vertical cross-section (for convenience, referred to as a third cross-section) cut parallel to short sides and passing through the center of the emitting surface 11 having a rectangular shape. The schematic view on the lower right is a vertical cross-section (for convenience, referred to as a fourth cross-section) cut parallel to long sides and passing through the center of the emitting surface 11 having the rectangular shape. FIG. 8 is a schematic perspective view of the light control unit illustrated in FIG. 7.

As illustrated in FIGS. 7 and 8, the emitting surface 11 is the rectangle having the short sides and the long sides in a top view. The radius of curvature of the emitting surface 11 is the same in the third cross-section and the fourth cross-section. In addition, a height of a portion, at which the emitting surfaces 11 of the adjacent light control units 10 are in contact with each other, from the lower end of the second incident surface 13 is represented as H2 in the fourth cross-section, which is smaller than H1 in the third cross-section.

That is, in FIGS. 7 and 8, an interval between the light control units 10 in the fourth cross-section is made wider than an interval between the light control units 10 in the third cross-section without changing the shape of the light control units 10 in the third cross-section and the fourth cross-section. Also in the case in which the emitting surface 11 has a shape of a rectangle, the shape illustrated in FIGS. 7 and 8 is adopted, so that the uniformity of the light emitted from the optical member can be improved, and the brightness unevenness can be reduced as in the case in which the emitting surface 11 has a shape of a square.

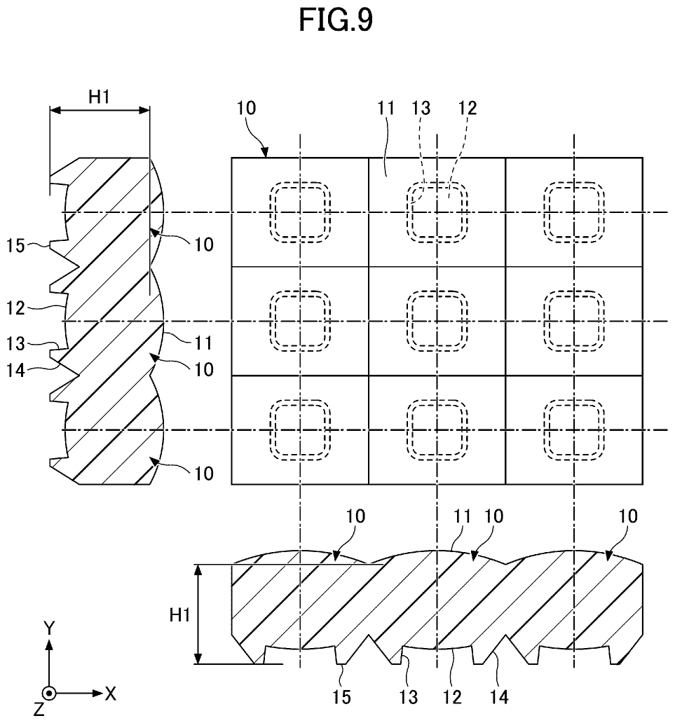

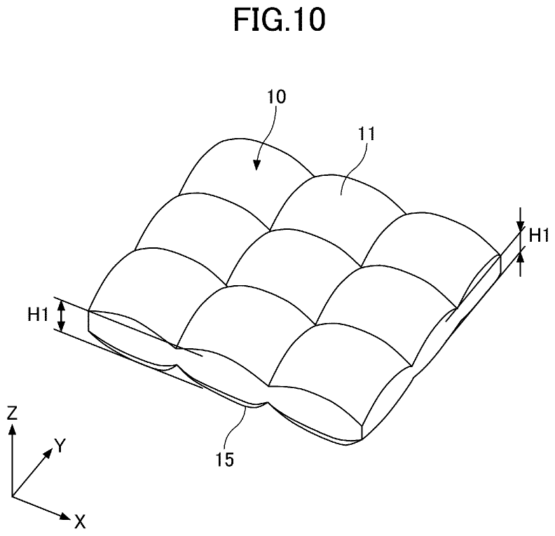

FIG. 9 illustrates schematic views (part 2) each illustrating the cross-sectional shape of the light control unit when the emitting surface has a shape of a rectangle. In FIG. 9, the schematic view on the upper right is a top view. The schematic view on the upper left is a vertical cross-section (for convenience, referred to as a third cross-section) cut parallel to short sides and passing through the center of the emitting surface 11 having a rectangular shape. The schematic view on the lower right is a vertical cross-section (for convenience, referred to as a fourth cross-section) cut parallel to long sides and passing through the center of the emitting surface 11 having the rectangular shape. FIG. 10 is a schematic perspective view of the light control unit illustrated in FIG. 9.

As illustrated in FIGS. 9 and 10, the emitting surface 11 has a shape of a rectangle having the short sides and the long sides in a top view. The radius of curvature of the emitting surface 11 is larger in the fourth cross-section than in the third cross-section. In addition, a height H1 of a portion, at which the emitting surfaces 11 of the adjacent light control units 10 are in contact with each other, from the lower end of the second incident surface 13 is the same in the third cross-section and the fourth cross-section.

That is, in FIGS. 9 and 10, the shape of the light control unit 10 differs between the third cross-section and the fourth cross-section. This shape is effective in a case in which an aspect ratio of the long side and the short side of the emitting surface 11 is increased and the brightness unevenness cannot be dealt with only by widening the interval between the light control units 10 as illustrated in FIGS. 7 and 8. Also in the case in which the emitting surface 11 has a shape of a rectangle, the shape illustrated in FIGS. 9 and 10 is adopted, so that the uniformity of the light emitted from the optical member can be improved, and the brightness unevenness can be reduced as in the case in which the emitting surface 11 has a shape of a square.

In FIGS. 9 and 10, if necessary, an inclination angle of the reflective surface 14 in the fourth cross-section may be set gentler than an inclination angle of the reflective surface 14 in the third cross-section.

### Modified Example of Optical Member

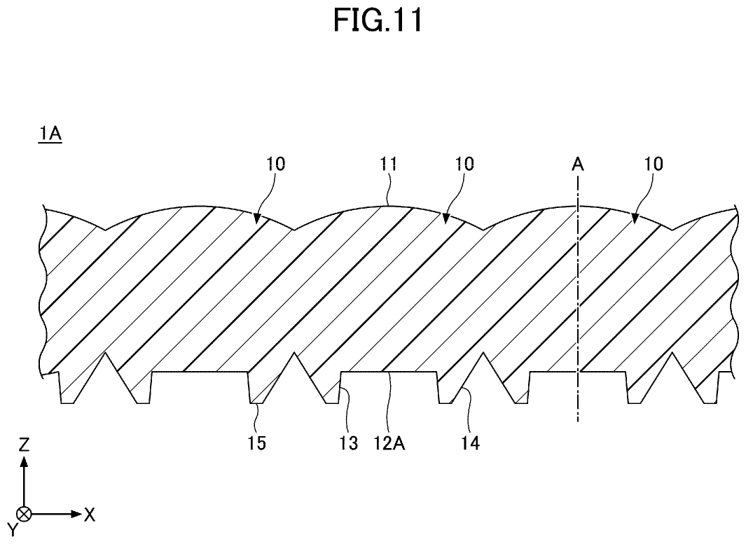

FIG. 11 is a schematic cross-sectional view exemplifying an optical member according to a first modified example of the first embodiment. As illustrated in FIG. 11, an optical member 1A is different from the optical member 1 in which the first incident surface 12 is the convex surface in that a first incident surface 12A is a flat surface in each of the light control units 10. The first incident surface 12A extends, for example, in a plane parallel to a horizontal plane when the optical member 1A is placed on the horizontal plane with the first incident surface 12A facing downward.

As described above, the first incident surface 12A may be a flat surface. Also in this case, similarly to the case in which the radius of curvature of the first incident surface 12 is increased in the optical member 1, a degree of light focusing on the incident side can be reduced, and the light can be spread inside the light control unit 10. Thus, in the optical member 1A, an effect the same as or similar to that of the optical member 1 can be obtained.

### Light Source Module 300

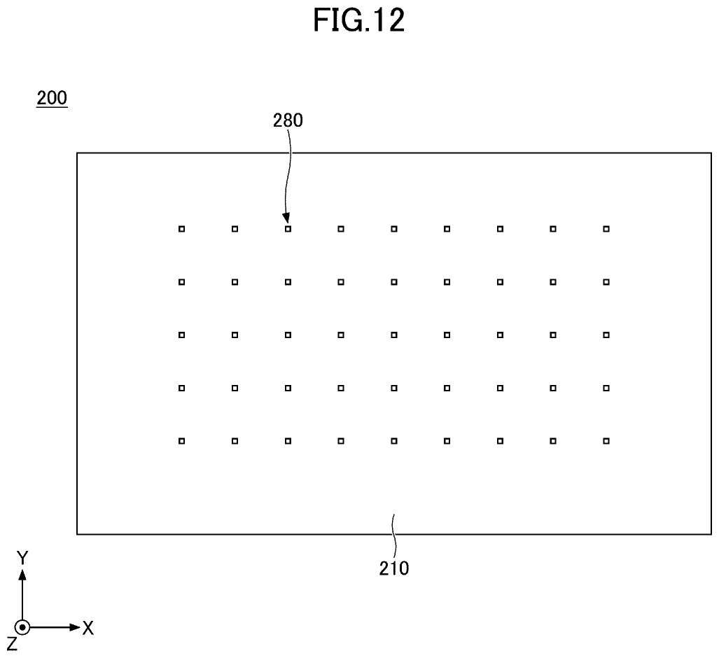

Here, a light source module including a planar light source and an optical member will be described. Firstly, the planar light source will be described. FIG. 12 is a schematic top view exemplifying a planar light source. A planar light source 200 illustrated in FIG. 12 includes a substrate 210 and a plurality of light sources 280 disposed on the substrate 210. The plurality of light sources 280 are two-dimensionally arranged in a matrix on the substrate 210, for example.

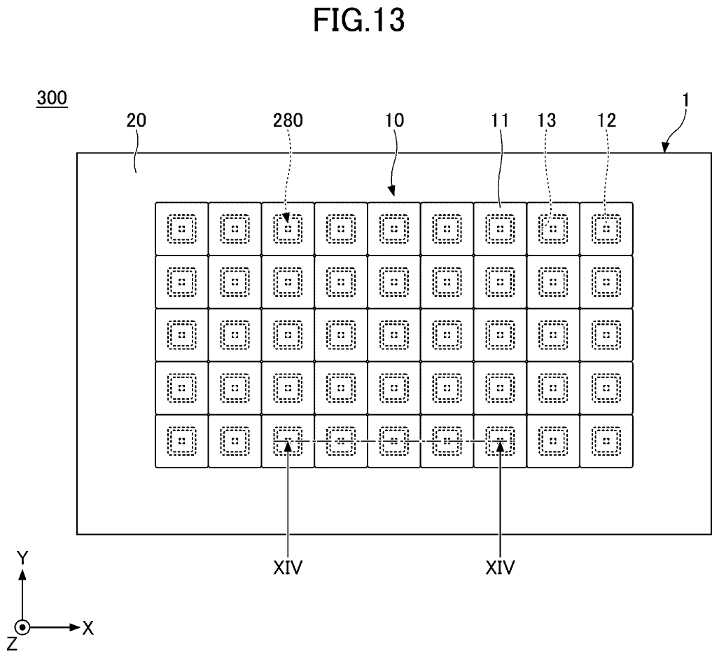

FIG. 13 is a schematic top view exemplifying a light source module including a planar light source and an optical member. FIG. 14 is a schematic cross-sectional view exemplifying the light source module including the planar light source and the optical member taken along the line XIV-XIV in FIG. 13.

As illustrated in FIGS. 13 and 14, a light source module 300 includes the planar light source 200 and the optical member 1 disposed above the light sources 280 of the planar light source 200. The planar light source 200 and the optical member 1 are held by a housing so as to have a predetermined positional relationship, for example.

In the example of FIGS. 13 and 14, in the light source module 300, the number of the light sources 280 is equal to the number of the light control units 10. Each of the light sources 280 overlaps corresponding one of the first incident surfaces 12 of the light control units 10 located above the light source 280 in a top view. The expression “the light source 280 overlaps the first incident surface 12 of the light control unit 10 in a top view” means that a light-emitting surface of the light source 280 overlaps the first incident surface 12 of the light control unit 10 in a top view. In addition, the center of the light source 280 preferably coincides with the center of first incident surface 12 in a top view. When a light emission center (a location having the highest brightness on the light-emitting surface) of the light source 280 is displaced from the geometric center of the light source 280, the light emission center but not the geometric center of the light source 280 preferably coincides with the center of the first incident surface 12.

In FIG. 14, a pitch P1 is a distance in the X-axis direction connecting the centers of two adjacent light sources 280 in a top view. A pitch P2 is a distance in the X-axis direction connecting the centers of two adjacent light control units 10 in a top view. In the X-axis direction of the light source module 300, the pitch P1 of the light sources 280 is preferably equal to the pitch P2 of the light control units 10. In addition, in the Y-axis direction of the light source module 300, the pitch of the light sources 280 is preferably equal to the pitch of the light control units 10. Thus, the first incident surface 12 and the second incident surface 13 are easily irradiated with the entire light emitted from the light source 280, and therefore light use efficiency can be improved.

In the light source module 300, the number of the light sources 280 may be less than the number of the light control units 10. For example, the light source 280 may include a light-emitting surface divided into a plurality of regions. Also in this case, the light source 280 overlaps the first incident surface 12 of the light control unit 10 in a top view. That is, each of the light-emitting surfaces of the light source 280 overlaps the first incident surface 12 of the light control unit 10 in a top view.

In the light source module 300, light emitted from the light source 280 travels in a vertical direction and in an obliquely upward direction from the light source 280, and is incident on the first incident surface 12 and the second incident surface 13 of the light control unit 10 located above the light source 280. The light incident on the first incident surface 12 is focused by the light control unit 10 and emitted from the emitting surface 11 to the outside of the light source module 300. The light incident on the second incident surface 13 is reflected by the reflective surface 14 and emitted from the emitting surface 11 to the outside of the light source module 300.

Here, members included in the planar light source 200 will be described in detail.

### Substrate 210

A substrate 210 is a member on which the plurality of light sources 280 are placed. A conductor wiring line for supplying electric power to the light source 280 is disposed on an upper surface of the substrate 210.

Examples of a base material of the substrate 210 include ceramics, resins, and composite materials. Examples of the resins include phenol resin, epoxy resin, polyimide resin, BT resin, polyphthalamide (PPA), and polyethylene terephthalate (PET). Examples of the composite material include a mixture of any of the above-mentioned resins with glass fiber, silicon oxide, titanium oxide, and aluminum oxide, and a metal substrate in which a metal member is coated with an insulating layer.

The thickness of the substrate 210 can be appropriately selected. The substrate 210 can be either a flexible substrate that can be manufactured in roll-to-roll processing or a rigid substrate. The rigid substrate may be a thin rigid substrate that can be curved.

A light reflective member 220 is preferably provided around the light source 280 on the upper surface of the substrate 210. The light reflective member 220 is preferably made of an insulating material. As the material of the light reflective member 220, for example, a material including at least one of a material obtained by mixing a filler such as barium titanate, titanium oxide, aluminum oxide, silicon oxide, or zinc oxide with any of the resins exemplified as the material of the substrate 210, and a material in which a plurality of fine bubbles are contained in any of the resins exemplified as the material of the substrate 210 can be used.

When the planar light source 200 and the optical member 1 constitute the light source module 300, the light reflective member 220 is provided on the upper surface of the substrate 210, so that the light emitted upward from the light source 280 and reflected downward by the optical member 1 is reflected upward again by the light reflective member 220 and enters the optical member 1. As a result, a light-extracting efficiency of the light source module 300 can be improved.

### Light Source 280

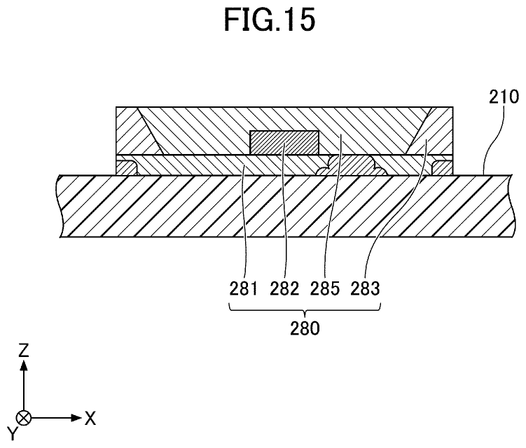

FIG. 15 is a schematic cross-sectional view exemplifying a light source mounted on the planar light source. The light source 280 has, for example, a shape of a quadrangle in a top view, but may be a circular shape or the like. An upper surface of the light source 280 is the light-emitting surface.

In the example of FIG. 15, the light source 280 is a light-emitting device including a lead, a resin molded body, and a light-emitting element. In the light-emitting device, for example, portions of a pair of leads 281 each having a plate shape are embedded in a resin-molded body 283. The resin-molded body 283 and the pair of leads 281 constitute a support body, and the support body includes a recessed portion defined by a bottom surface and a lateral surface. The bottom surface defining the recessed portion is constituted by the resin-molded body 283 and the portions of the pair of leads 281, and the lateral surface includes a reflective surface having a predetermined inclination angle.

A space between the pair of leads 281 is filled with the resin-molded body 283 and constitutes a portion of the bottom surface defining the recessed portion. The resin-molded body 283 has, for example, a shape of a quadrangle in a top view. On the lower surface of the resin-molded body 283, portions of the pair of leads 281 are exposed as external terminal portions. In the light-emitting device, the light-emitting element 282 may be placed in the recessed portion, and the light-emitting element 282 may be covered with a sealing member 285.

As a base material constituting the lead 281, for example, a plate-like body containing at least one kind of metal selected from copper, aluminum, gold, silver, tungsten, iron, and nickel, an alloy such as an iron-nickel alloy or phosphor bronze, or a clad material can be used. To efficiently extract light from the light-emitting element 282, a film containing silver, aluminum, gold, or an alloy thereof (for example, a film formed by plating) may be formed on the surfaces of the leads 281. The film of metal formed on the surfaces of the leads 281 may be a single-layer film or a multilayer film.

As the resin-molded body 283, a resin containing a thermosetting resin or a thermoplastic resin can be used. In particular, a thermosetting resin is preferably used. The thermosetting resin preferably has a gas permeability lower than a gas permeability of a resin used for the sealing member 285. Specific examples of the thermosetting resin include an epoxy resin, a silicone resin, a modified epoxy resin such as a silicone-modified epoxy resin, a modified silicone resin such as an epoxy-modified silicone resin, polyimide resins, modified polyimide resins, urethane resins, and modified urethane resins. The resin-molded body 283 may contain glass fiber, titanium oxide, aluminum oxide, silicon oxide, or the like.

The light-emitting element 282 is mounted on, for example, the bottom surface defining the recessed portion. The light-emitting element 282 is fixed to the lead 281 by, for example, a joining member. The light-emitting element 282 includes a pair of positive and negative electrodes, and the pair of positive and negative electrodes are electrically connected to the pair of leads 281 via wires, respectively. The light source 280 can emit light by receiving power supply from an external source via the pair of leads 281.

For example, a light-emitting diode is preferably used as the light-emitting element 282. As the light-emitting element 282, a light-emitting element having any wavelength can be selected. The light-emitting element 282 emits, for example, blue light, green light, and red light. The light-emitting element 282 includes a semiconductor layered body. The semiconductor layered body includes an n-type semiconductor layer, a p-type semiconductor layer, and a light-emitting layer interposed therebetween. The light-emitting layer may have a structure such as a double heterojunction or a single quantum well (SQW) or may have a structure with a group of active layers such as a multiple quantum well (MQW). The semiconductor layered body may include a plurality of light-emitting layers. For example, the semiconductor layered body may have a structure including two or more light-emitting layers between the n-type semiconductor layer and the p-type semiconductor layer or may have a structure in which a plurality of structures, each of which sequentially includes the n-type semiconductor layer, the light-emitting layer, and the p-type semiconductor layer, are repeatedly formed. When the semiconductor layered body includes a plurality of light-emitting layers, emission peak wavelengths may differ between the plurality of light-emitting layers, or light-emitting layers having the same emission peak wavelength may be included in the semiconductor layered body. For the light-emitting element 282, those using a nitride-based semiconductor such as GaN, InGaN, AlGaN, or AlInGaN can be used. For the red light-emitting element, GaAlAs, AlInGaP, or the like can be used. Further, a semiconductor light-emitting element formed using a material other than those may be used. The composition, light-emitting color, size, number, and the like of the light-emitting elements to be used can be appropriately selected according to the purpose.

The light-emitting element 282 is covered with the sealing member 285 having transmissivity. A resin having high heat resistance, weather resistance, and light resistance is preferably used as the sealing member 285. Examples of such a resin include a silicone resin, a modified silicone resin, an epoxy resin, a modified epoxy resin, a urea resin, a phenol resin, an acrylic resin, a urethane resin, a fluororesin, or a resin containing two or more kinds of these resins.

For the sealing member 285 to have a predetermined function, at least one selected from the group consisting of a filler, a pigment, and a phosphor can be mixed into the sealing member 285. As the filler, barium titanate, titanium oxide, aluminum oxide, silicon oxide, zinc oxide, or the like can be suitably used. Further, the sealing member 285 may contain an organic or inorganic coloring dye or coloring pigment for the purpose of transmitting a desired wavelength range. Further, the sealing member 285 may contain a phosphor.

When the sealing member 285 contains a phosphor, the sealing member 285 functions as a wavelength conversion member. The wavelength conversion member absorbs at least a part of light emitted from the light-emitting element 282, and emits light having a wavelength different from a wavelength of the light emitted from the light-emitting element 282. For example, the wavelength conversion member converts a wavelength of a part of blue light from the light-emitting element 282, and emits yellow light. According to such a configuration, white light is obtained by mixing blue light that has passed through the wavelength conversion member and yellow light emitted from the wavelength conversion member.

The light source 280 may be the light-emitting element 282 instead of the light-emitting device as illustrated in FIG. 15. In this case, a light reflective film may be included on an upper surface of the light-emitting element 282. The light reflective film may be, for example, any of a metal film of silver or aluminum, a dielectric multilayer film, a resin containing a filler such as barium titanate, titanium oxide, aluminum oxide, silicon oxide, or zinc oxide, and a combination thereof. A light-transmissive sealing member covering the light-emitting element 282 may be provided on the upper surface of the substrate 210. As the material of the sealing member, a light-transmissive resin such as an epoxy resin, a silicone resin, or a resin obtained by mixing them, glass, or the like can be used. Of these, the silicone resin is preferably used in consideration of light resistance and ease of forming. The sealing member can contain a diffusing agent for diffusing light from the light-emitting element 282, a coloring agent corresponding to the light-emitting color of the light-emitting element 282, and the like. As the diffusing agent, the coloring agent, and the like, those known in the art can be employed.

### Another Example of Light Source Module

Another example of a light source module including a planar light source and an optical member will be described below. The light source module may include a diffusion sheet. When the optical axis is bent, the light source module may also include a prism sheet. Further, the light source module may include the diffusion sheet and the prism sheet. Specific examples will be illustrated below.

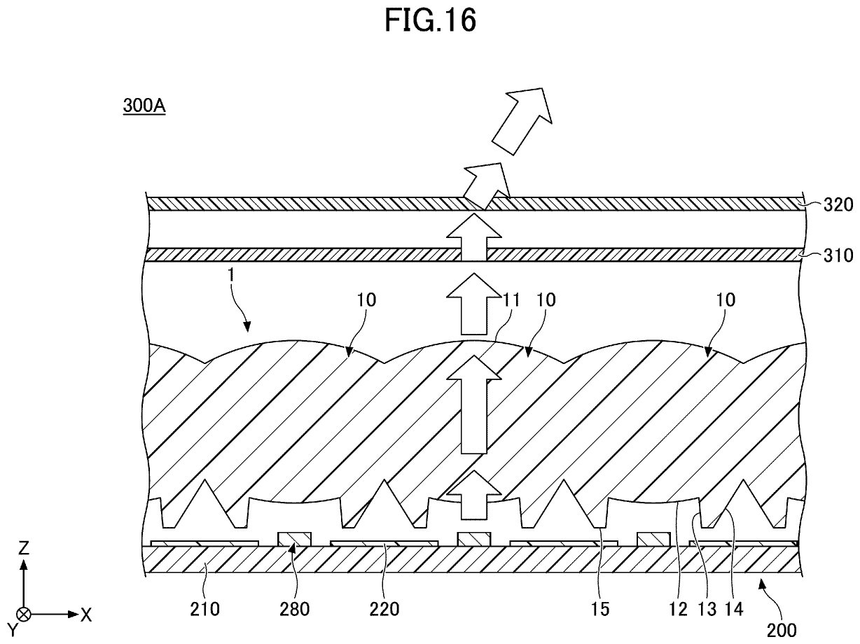

FIG. 16 is a schematic partial cross-sectional view (part 1) exemplifying another example of the light source module. A light source module 300A illustrated in FIG. 16 includes a diffusion sheet 310 and a prism sheet 320 in this order above the optical member 1.

When the light source module 300A includes the diffusion sheet 310, the uniformity of light extracted from the light source module 300A to the outside can be improved. In addition, when the light source module 300A includes the prism sheet 320, the direction of optical axis of the light extracted from the light source module 300A to the outside can be changed to a predetermined direction. A positional relationship between the diffusion sheet 310 and the prism sheet 320 may be vertically inverted to that illustrated in FIG. 16.

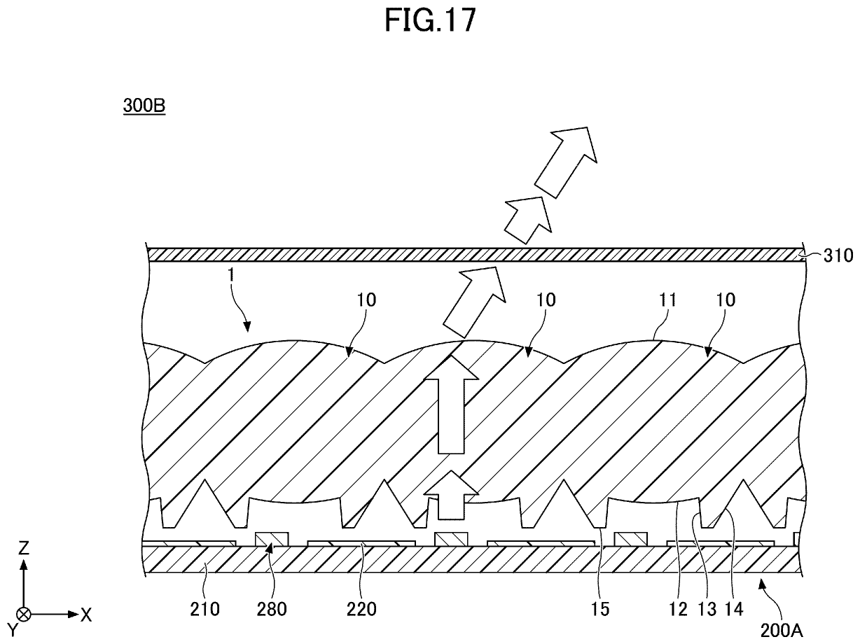

FIG. 17 is a schematic partial cross-sectional view (part 2) exemplifying another example of the light source module. A light source module 300B illustrated in FIG. 17 is different from the light source module 300A illustrated in FIG. 16 in that the light source module 300B does not include the prism sheet 320. In addition, the light source module 300B illustrated in FIG. 17 is different from the light source module 300A illustrated in FIG. 16 in that the light source module 300B includes a planar light source 200A instead of the planar light source 200.

In the planar light source 200A, the optical axis of each of the optical members 1 and the optical axis of each of the light sources 280 are shifted from each other in the X-axis direction. Thus, even when the light source module 300B does not include the prism sheet, the direction of optical axis of the light extracted from the light source module 300B to the outside can be changed to a predetermined direction. The direction of optical axis of each of the optical members 1 and the direction of optical axis of each of the light sources 280 may be shifted from each other in the Y-axis direction, or may be shifted from each other in both the X-axis direction and the Y-axis direction.

In the examples of FIGS. 12 to 17, the planar light sources used in the light source module have been described as including the substrate, but the substrate is provided as necessary and can be omitted. For example, in the light source module, a planar light source in which a plurality of light-emitting elements are held by a monolithic light-transmissive resin or the like can be used.

### Liquid Crystal Display Device

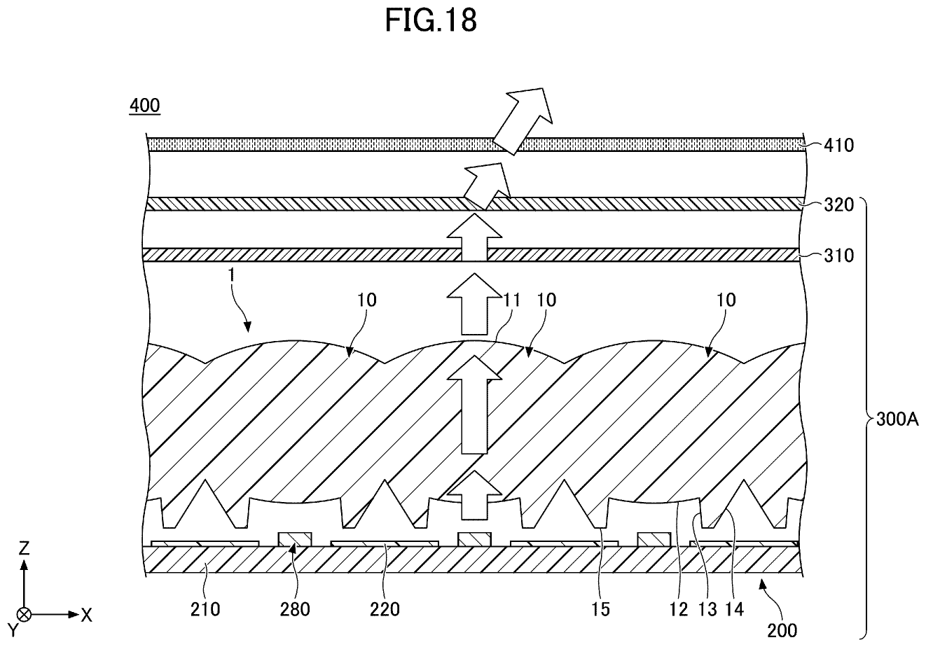

FIG. 18 is a schematic partial cross-sectional view exemplifying a liquid crystal display device including a light source module. A liquid crystal display device 400 illustrated in FIG. 18 includes the light source module 300A and a liquid crystal panel 410. In the liquid crystal display device 400, light emitted from the light source module 300A is incident on the liquid crystal panel 410, and an image is displayed on the liquid crystal panel 410.

The light emitted from the light source module 300A has a deviated angle. Thus, for example, when the liquid crystal display device 400 is incorporated in a head-up display system and a distortion of a virtual image is removed by adjusting an installation angle of the light source module 300A, an influence of an optical axis deviation occurring on the virtual image side can be suppressed.

In the liquid crystal display device 400, the light source module 300 or the light source module 300B may be used instead of the light source module 300A. When the light source module 300 is used in the liquid crystal display device 400, the prism sheet 320 may be disposed on the opposite side to the light source module 300 with the liquid crystal panel 410 interposed therebetween.

Preferred embodiments and the like have been described in detail above. However, the invention is not limited to the above-described embodiments and the like, and various modifications and substitutions can be made to the above-described embodiments and the like without departing from the scope described in the claims.

What is claimed is:

1. An optical member comprising:
a plurality of light control units, each comprising:
an upper surface serving as an emitting surface,
a first incident surface located below the emitting surface,
a second incident surface located at an outer periphery of the first incident surface in a top view, and extending downward from a first incident surface side, and
a reflective surface located at an outer periphery of the second incident surface in the top view, and inclined in a direction away from a center of the light control unit so as to extend closer to the emitting surface from a vicinity of the second incident surface;
wherein:
the light control units are configured such that light incident on the first incident surface and the second incident surface, and light reflected by the reflective surface are emitted from the emitting surface;
the first incident surface is a convex surface curved in a direction away from the emitting surface;
the emitting surface is a convex surface curved in a direction away from the first incident surface;
a radius of curvature of the first incident surface is larger than a radius of curvature of the emitting surface in a cross-sectional view; and
the emitting surfaces of adjacent ones of the light control units are directly connected to each other.

2. The optical member according to claim 1, wherein the emitting surface and the first incident surface have a shape of a square or a rectangle in the top view.

3. The optical member according to claim 2, wherein, when a vertical cross-section cut parallel to one side of the emitting surface and passing through a center of the emitting surface is defined as a first cross-section, and a vertical cross-section cut along a diagonal line of the emitting surface is defined as a second cross-section, an angle formed by a center line of the light control unit and the reflective surface is larger in the second cross-section than in the first cross-section.

4. The optical member according to claim 1, wherein a center of the first incident surface coincides with a center of the emitting surface in the top view.

5. The optical member according to claim 1, wherein:
the emitting surface has a shape of a rectangle having short sides and long sides in the top view; and
when a vertical cross-section cut parallel to the short sides and passing through a center of the rectangle is defined as a third cross-section, and a vertical cross-section cut parallel to the long sides and passing through the center of the rectangle is defined as a fourth cross-section, a height of a portion, at which the emitting surfaces of the light control units adjacent to each other are in contact with each other, from a lower end of the second incident surface is smaller in the fourth cross-section than in the third cross-section.

6. The optical member according to claim 1, wherein:
the emitting surface has a shape of a rectangle having short sides and long sides in the top view; and
when a vertical cross-section cut parallel to the short sides and passing through a center of the rectangle is defined as a third cross-section, and a vertical cross-section cut parallel to the long sides and passing through the center of the rectangle is defined as a fourth cross-section, a radius of curvature of the emitting surface is larger in the fourth cross-section than in the third cross-section.

7. A light source module comprising:
a planar light source comprising a substrate, and a plurality of light sources disposed on the substrate; and
the optical member according to claim 1 disposed above the plurality of light sources.

8. The light source module according to claim 7, wherein a center of at least one of the light sources coincides with a center of each corresponding one of the first incident surfaces in the top view.

9. A liquid crystal display device comprising the light source module according to claim 7.

10. An optical member comprising:
a plurality of light control units, wherein each of the light control units comprises:
an upper surface serving as an emitting surface,
a first incident surface located below the emitting surface,
a second incident surface located at an outer periphery of the first incident surface in a top view, and extending downward from a first incident surface side, and
a reflective surface located at an outer periphery of the second incident surface in the top view, and inclined in a direction away from a center of the light control unit so as to extend closer to the emitting surface from a vicinity of the second incident surface;
wherein:
the light control units are configured such that light incident on the first incident surface and the second incident surface, and light reflected by the reflective surface are emitted from the emitting surface;
the first incident surface is a flat surface;
the emitting surface is a convex surface curved in a direction away from the first incident surface; and
the emitting surfaces of adjacent ones of the light control units are directly connected to each other.

11. The optical member according to claim 10, wherein the emitting surface and the first incident surface each have a shape of a square or a rectangle in the top view.

12. The optical member according to claim 10, wherein, when a vertical cross-section cut parallel to one side of the emitting surface and passing through a center of the emitting surface is defined as a first cross-section, and a vertical cross-section cut along a diagonal line of the emitting surface is defined as a second cross-section, an angle formed by a center line of the light control unit and the reflective surface is larger in the second cross-section than in the first cross-section.

13. The optical member according to claim 10, wherein a center of the first incident surface coincides with a center of the emitting surface in the top view.

14. The optical member according to claim 10, wherein:
the emitting surface has a shape of a rectangle having short sides and long sides in the top view; and
when a vertical cross-section cut parallel to the short sides and passing through a center of the rectangle is defined as a third cross-section, and a vertical cross-section cut parallel to the long sides and passing through the center of the rectangle is defined as a fourth cross-section, a height of a portion, at which the emitting surfaces of the light control units adjacent to each other are in contact with each other, from a lower end of the second incident surface is smaller in the fourth cross-section than in the third cross-section.

15. The optical member according to claim 10, wherein:
the emitting surface has a shape of a rectangle having short sides and long sides in the top view; and
when a vertical cross-section cut parallel to the short sides and passing through a center of the rectangle is defined as a third cross-section, and a vertical cross-section cut parallel to the long sides and passing through the center of the rectangle is defined as a fourth cross-section, a radius of curvature of the emitting surface is larger in the fourth cross-section than in the third cross-section.

16. A light source module comprising:
a planar light source comprising a substrate, and a plurality of light sources disposed on the substrate; and
the optical member according to claim 10 disposed above the plurality of light sources.

17. A light source module comprising:
a planar light source comprising a substrate and a plurality of light sources disposed on the substrate; and
the optical member according to claim 14 disposed above the plurality of light sources.

18. A light source module comprising:
a planar light source comprising a substrate and a plurality of light sources disposed on the substrate; and
the optical member according to claim 15 disposed above the plurality of light sources.

19. A liquid crystal display device comprising the light source module according to claim 17.

20. A liquid crystal display device comprising the light source module according to claim 18.
